(19) United States
(12) Patent Application Publication
(10) Pub. No.: US 2022/0126817 A1
(43) Pub. Date: Apr. 28, 2022

(54) SEMI-AUTONOMOUS PARKING OF A FOLLOWER VEHICLE

(71) Applicant: GM Global Technology Operations LLC, Detroit, MI (US)

(72) Inventors: Carlos E. Arreaza, Oakville (CA); Hojjat Izadi, Toronto (CA); Fred W. Huntzicker, Ann Arbor, MI (US)

(21) Appl. No.: 17/080,086

(22) Filed: Oct. 26, 2020

(51) Int. Cl. B60W 30/06; B60W 30/165; G05D 1/02; G05D 1/00; H04W 4/46

(52) U.S. Cl. CPC B60W 30/06; B60W 30/165; G05D 1/0295; B60W 2556/65; G05D 1/0022; H04W 4/46; B60W 2540/18; G05D 1/0016

(57) ABSTRACT

Systems and methods to park a semi-autonomous follower vehicle involve performing path planning to determine a path from a current location of the follower vehicle to a parking space, and controlling longitudinal movement of the follower vehicle using an accelerator control mechanism and a brake control mechanism operated by a driver of a leader vehicle that is not physically coupled to the follower vehicle. The accelerator control mechanism includes a pedal, knob, or lever and the brake control mechanism includes a pedal, knob, or lever. Lateral movement of the follower vehicle is controlled in order to follow the path to the parking space.

### INTRODUCTION

The subject disclosure relates to semi-autonomous parking of a follower vehicle.

In the autonomous vehicle space, platooning refers to a group of vehicles that communicate with each other to form a platoon or flock in which the lead vehicle controls the speed and each of the follower vehicles maintains that speed. This configuration may improve travel time and increase lane capacity, for example. A significant step toward the development of a platoon of autonomous vehicles is a leader-follower configuration. According to the arrangement, a leader vehicle that includes a driver leads a driverless follower vehicle that is semi-autonomous. Accordingly, it is desirable to provide semi-autonomous parking of a follower vehicle.

### SUMMARY

In one exemplary embodiment, a method of parking a semi-autonomous follower vehicle includes performing, by a processor of the follower vehicle, path planning to determine a path from a current location of the follower vehicle to a parking space, and controlling, via vehicle-to-vehicle (V2V) communication, longitudinal movement of the follower vehicle using an accelerator control mechanism and a brake control mechanism operated by a driver of a leader vehicle that is not physically coupled to the follower vehicle. The accelerator control mechanism includes a pedal, knob, or lever and the brake control mechanism includes a pedal, knob, or lever. The processor of the follower vehicle controls lateral movement of the follower vehicle in order to follow the path to the parking space.

In addition to one or more of the features described herein, the method also includes initiating the method from a start position at the current location, wherein the initiating includes putting the leader vehicle in park and the start position provides an unobstructed view of the path to the driver of the leader vehicle.

In addition to one or more of the features described herein, the initiating the method from the start position includes the leader vehicle being ahead of the follower vehicle at the current location such that the path is a reverse path from the current location to the parking space.

In addition to one or more of the features described herein, the initiating the method from the start position includes the leader vehicle being behind the follower vehicle at the current location such that the path is a forward path from the current location to the parking space.

In addition to one or more of the features described herein, the controlling the longitudinal movement of the follower vehicle via V2V communication refers to the follower vehicle obtaining a position of the accelerator control mechanism and the brake control mechanism of the leader vehicle via V2V communication.

In addition to one or more of the features described herein, the controlling the longitudinal movement of the follower vehicle includes mapping the position of the accelerator control mechanism and the brake control mechanism of the leader vehicle to a speed of the follower vehicle.

In addition to one or more of the features described herein, the controlling the lateral movement of the follower vehicle includes determining, by the processor of the follower vehicle, a steering angle continuously during movement of the follower vehicle from the current location to the parking space.

In addition to one or more of the features described herein, the controlling the lateral movement of the follower vehicle includes adding a bias to the steering angle determined by the processor of the follower vehicle based on V2V communication.

In addition to one or more of the features described herein, the adding the bias includes communicating a movement of a steering wheel of the leader vehicle by the driver of the leader vehicle.

In addition to one or more of the features described herein, the adding the bias includes the driver of the leader vehicle viewing sensor images obtained by the follower vehicle and provided via the V2V communication.

In another exemplary embodiment, a system to perform semi-autonomous parking includes a processor of a follower vehicle to perform path planning to determine a path from a current location of the follower vehicle to a parking space and to control lateral movement of the follower vehicle in order to follow the path to the parking space. The system also includes a leader vehicle that is not physically coupled to the follower vehicle and controls, via vehicle-to-vehicle (V2V) communication, longitudinal movement of the follower vehicle using an accelerator control mechanism and a brake control mechanism operated by a driver of the leader vehicle. The accelerator control mechanism includes a pedal, knob, or lever and the brake control mechanism includes a pedal, knob, or lever.

In addition to one or more of the features described herein, the leader vehicle initiates the semi-autonomous parking of the follower vehicle based on the leader vehicle being put in park.

In addition to one or more of the features described herein, the leader vehicle is ahead of the follower vehicle at the current location such that the path is a reverse path from the current location to the parking space.

In addition to one or more of the features described herein, the leader vehicle is behind the follower vehicle at the current location such that the path is a forward path from the current location to the parking space.

In addition to one or more of the features described herein, the follower vehicle obtains a position of the accelerator control mechanism and the brake control mechanism of the leader vehicle via V2V communication.

In addition to one or more of the features described herein, the follower vehicle maps the position of the accelerator control mechanism and the brake control mechanism of the leader vehicle to a speed of the follower vehicle.

In addition to one or more of the features described herein, the follower vehicle determines a steering angle continuously during movement of the follower vehicle from the current location to the parking space.

In addition to one or more of the features described herein, the leader vehicle adds a bias to the steering angle determined by the follower vehicle based on the V2V communication.

In addition to one or more of the features described herein, the bias is added as a movement of a steering wheel of the leader vehicle by the driver of the leader vehicle that is communicated via the V2V communication.

In addition to one or more of the features described herein, the leader vehicle includes a display of sensor images obtained by the follower vehicle and provided via V2V communication.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates semi-autonomous parking of a follower vehicle according to one or more embodiments;

FIG. 2 is a process flow of a method of performing semi-autonomous parking of a follower vehicle according to one or more embodiments; and

FIG. 3 illustrates semi-autonomous parking of a follower vehicle according to an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, a leader-follower configuration involves a leader vehicle with a driver and a semi-autonomous, driverless follower vehicle. Embodiments of the systems and methods detailed herein relate to semi-autonomous parking of a follower vehicle. The semi-autonomous follower vehicle may be a trailer that accommodates another vehicle (e.g., boat, other watercraft, all-terrain vehicle), a travel trailer, or other driverless platform that may previously have been physically towed by the leader vehicle. When the follower vehicle is following the leader vehicle, the follower vehicle maintains a prescribed distance behind the leader vehicle based on line-of-sight between sensors of both the leader vehicle and the follower vehicle and without any physical connection between the two. In order to park the follower vehicle, according to embodiments detailed herein, the leader vehicle and the follower vehicle each provide different aspects of the control.

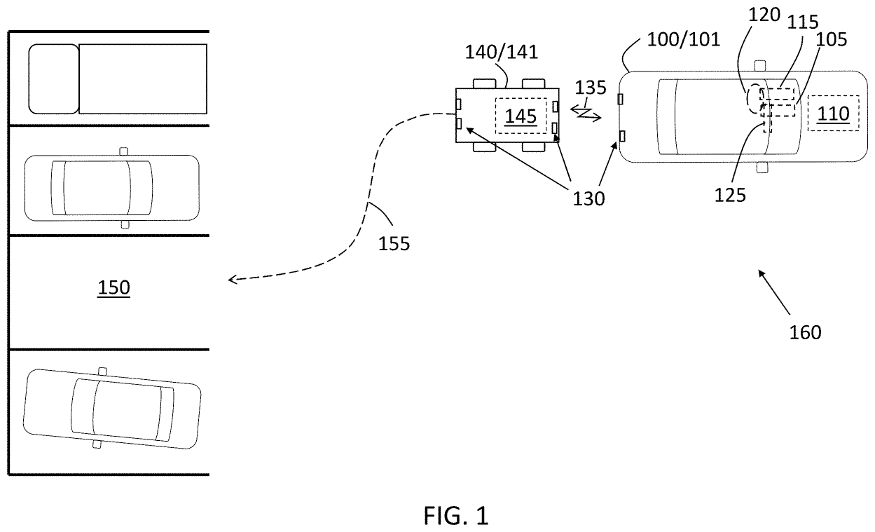

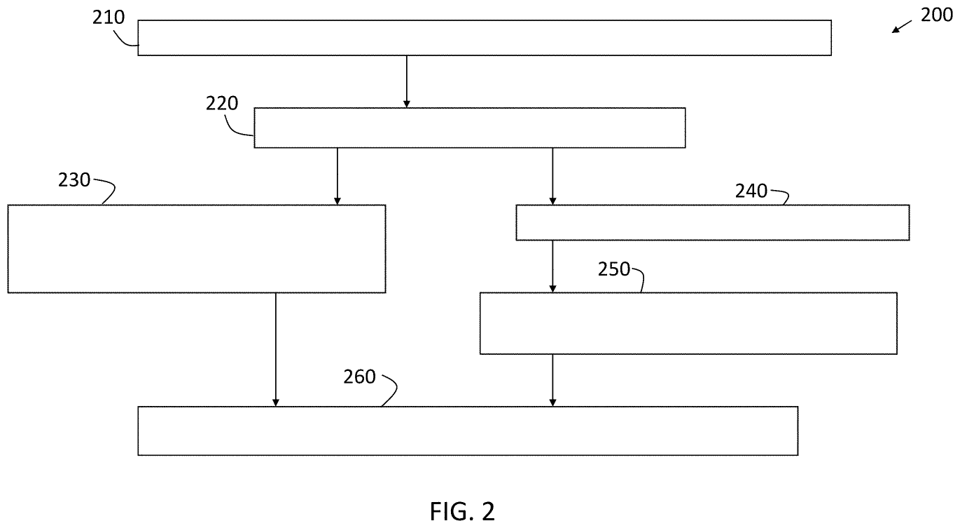

In accordance with an exemplary embodiment, FIG. 1 illustrates semi-autonomous parking of a follower vehicle 140 according to one or more embodiments. A leader vehicle 100 and a follower vehicle 140 are shown. The exemplary leader vehicle 100 shown in FIG. 1 is an automobile 101, but the leader vehicle 100 may be a truck, farm equipment, construction equipment, or any conveyance with a driver, according to alternate embodiments. The exemplary follower vehicle 140 shown in FIG. 1 is a travel trailer 141 but, as previously noted, the follower vehicle 140 may alternately be any type of driverless vehicle that may have been physically towed prior to the leader-follower configuration. A parking space 150 is indicated. As detailed with reference to FIG. 2, the follower vehicle 140 parks in the parking space 150 through semi-autonomous operation. Specifically, the steering is primarily controlled by the follower vehicle 140 itself, while the acceleration/deceleration is controlled by the driver of the leader vehicle 100.

The leader vehicle 100 and the follower vehicle 140 include sensors 130 (e.g., cameras, lidar systems, radar systems, global navigation satellite system such as global positioning system). According to an exemplary embodiment, sensors 130 are indicated on the back of the leader vehicle 100 and on both ends of the follower vehicle 140. The numbers and locations of the sensors 130 on either the leader vehicle 100 or the follower vehicle 140 are not limited by the exemplary illustration. In addition, while sensors 130 that obtain information about the environment around the vehicles 100, 140 have been noted, one or both of the vehicles 100, 140 may include additional sensors (e.g., inertial measurement unit, gyroscope) that provide information about the vehicle 100, 140 itself. The leader vehicle 100 includes an interface 125 with the driver. For example, the interface 125 may be part of the infotainment system that includes a display screen and provides touchscreen or other input by the driver.

The leader vehicle 100 includes an accelerator pedal 105, a brake pedal 115, and a steering wheel 120, all of which are operated by a driver of the leader vehicle 100. While pedals 105, 115 are shown and discussed for explanatory purposes, knobs, levers, or other control mechanisms may be employed to serve the same functions according to alternate embodiments. The leader vehicle 100 includes a controller 110 that, alone or in combination with other processing circuitry, controls aspects of the operation and communication of the leader vehicle 100. For example, the leader vehicle 100 and the follower vehicle 140 may perform vehicle-to-vehicle (V2V) communication, exchanging V2V messages 135. As detailed with reference to FIG. 2, the V2V communication from the leader vehicle 100 may indicate positions of the accelerator pedal 105 and brake pedal 115 of the leader vehicle 100, as well as movement of the steering wheel 120. V2V communication from the follower vehicle 140 to the leader vehicle 100 may provide data (e.g., images) obtained with one or more of its sensors 130 (e.g., cameras). Images obtained by the leader vehicle 100 from the follower vehicle 140 may be displayed by the interface 125 (e.g., infotainment screen) to the driver of the leader vehicle 100, for example.

The follower vehicle 140 is shown to include a controller 145. In addition to facilitating V2V communication with the leader vehicle 100, the controller 145 of the follower vehicle 140 may also perform and control implementation of the path planning that is discussed with reference to FIG. 2. Both the controller 110 of the leader vehicle 100 and the controller 145 of the follower vehicle 140 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The leader vehicle 100 and the follower vehicle 140 are shown in a start position 160 that allows initiation of the semi-autonomous parking process for the follower vehicle 140 based on a selected parking space 150. While reaching this start position 160 is outside the scope of the embodiments detailed herein, the conditions that define the start position 160 are briefly described, as are exemplary processes involved in selecting the parking space 120. Generally, the start position 160 is a relatively short distance from the parking space 150 and is a location at which the leader vehicle 100 may remain during the parking process.

In the start position 160, the driver of the leader vehicle 100 has a clear view of the path 155 that the follower vehicle 140 will take to the parking space 150. In addition, because the leader vehicle 100 remains stationary during the semi-autonomous parking process of the follower vehicle 140, the start position 160 should be one in which the leader vehicle 100 may briefly remain safely and without blocking others. Selection of the parking space 150 may be performed in different ways. If, as in the exemplary illustrated scenario, only one parking space 150 is available, then no selection process is needed.

When more than one potential parking space 150 is available, the driver of the leader vehicle 100 may select one of the potential parking spaces 150 via the interface 125 (e.g., via touchscreen on an image from a camera of the follower vehicle 140 that shows the parking spaces 150). The leader vehicle 100 may convey the selection via V2V communication to the follower vehicle 140. According to alternate embodiments, the follower vehicle 140 may perform a full or abbreviated path planning to each potential parking space 150 and provide a selection via V2V communication to the leader vehicle 100 based on the outcome of that path planning. For example, the path 155 to one of the potential parking spaces 150 may include a much sharper angle or proximity to another vehicle or object than the path 155 to a second potential parking space 150. Thus, the second potential parking space 150 may be selected. Path planning to determine the path 155 to a given parking space 150 is discussed with reference to FIG. 2.

FIG. 2 is a process flow of a method 200 of performing semi-autonomous parking of a follower vehicle 140 according to one or more embodiments. At block 210, initiating the parking process to a selected parking space 150 from a start position 160 entails several actions. As previously noted, the start position 160 should be one from which the driver of the leader vehicle 100 has an unobstructed view of the route between the follower vehicle 140 and the parking space 150 and at which the leader vehicle 100 may safely remain during the parking process of the follower vehicle 140. In addition, a parking space 150 is assumed to have been selected by either the leader vehicle 100 or the follower vehicle 140 but, by the initiation at block 210, both vehicles 100, 140 should be aware of the parking space 150 being targeted for the follower vehicle 100. Initiating the parking process, at block 210, involves the leader vehicle 140 being put in the park gear with the steering wheel 120 centered. Centering the steering wheel 120 allows the greatest degree of movement for the biasing discussed at block 250.

At block 220, performing path planning at the follower vehicle 140 refers to the controller 145 of the follower vehicle 140 using information from its sensors 130 to ascertain a path (i.e., route) to the parking space 150 that avoids other vehicles and objects. An exemplary dashed path is indicated in FIG. 1. The specific steering angles needed to follow the path 155 are determined continuously (at block 240) as the follower vehicle 140 moves generally along the path toward the parking space.

At block 230 controlling pedals 105, 115 of the leader vehicle 100 to control longitudinal movement of the follower vehicle 140 refers to actual longitudinal movement by the follower vehicle 140 being controlled by the driver of the leader vehicle 100. The positions of the accelerator pedal 105 and the brake pedal 115 are provided to the follower vehicle 140 via V2V communication from the leader vehicle 100. These position values are mapped to a speed for movement of the follower vehicle 140. Because the leader vehicle 100 is put in park (at block 210), depressing the accelerator pedal 105 does not result in movement of the leader vehicle 100. Parking the leader vehicle 100 or putting the leader vehicle 100 in park refers to engaging the park gear, putting the leader vehicle 100 in a neutral gear on a level surface, or otherwise preventing movement of the leader vehicle 100 when the pedals 105, 115 (or other accelerator or brake mechanisms) are operated or the steering wheel 120 is turned.

At block 240, controlling steering at the follower vehicle 140 refers to the controller 145 of the follower vehicle 140 performing known trajectory planning processes that result in the determination of a steering angle in order to follow the path determined during the path planning (at block 220). This process is performed continuously as the follower vehicle 140 moves along the path 155 to the parking space 150. At block 250, refining the steering control based on steering of the leader vehicle 100 refers to the fact that the driver of the leader vehicle 100 may move the steering wheel 120 of the (parked) leader vehicle 100 in order to affect steering of the follower vehicle 140. This steering by the driver acts as a bias on the steering determined by the controller 145 of the follower vehicle 140. For example, this refinement, at block 250, may be used by the driver of the leader vehicle 100 to park the follower vehicle 140 more to one side or the other rather than centered within the parking space 150 (e.g., for easier access to cargo).

At block 260, stopping movements of the follower vehicle 140 after the parking space 150 is reached refers to the driver of the leader vehicle 100 depressing the brake pedal 115 completely or operating an alternate brake mechanism of the leader vehicle 100 that completely stops motion and ends the parking process. In addition to the brake pedal 115 position being conveyed to the follower vehicle 140 via a V2V message, the ending of the parking process may be conveyed to the follower vehicle 140 as an additional message.

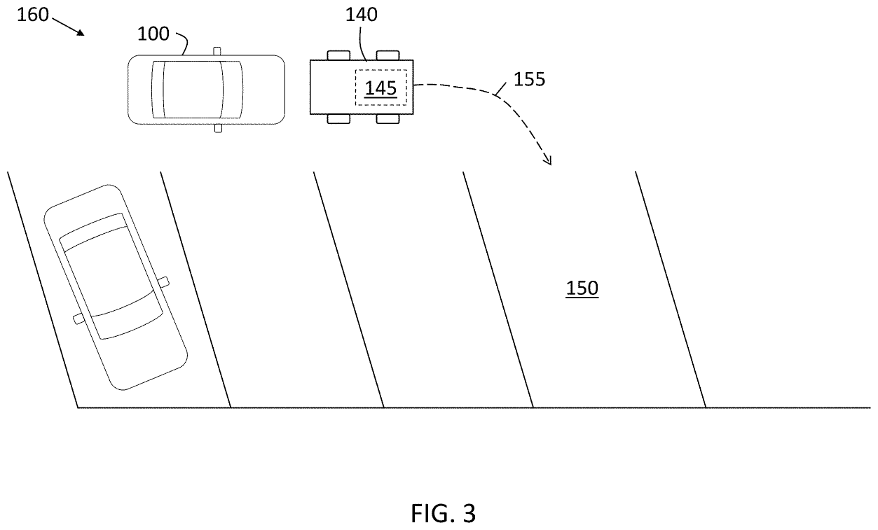

FIG. 3 illustrates semi-autonomous parking of a follower vehicle 140 according to an exemplary embodiment. According to the exemplary illustration in FIG. 1, the starting position for the parking process according to the method 200 involves the leader vehicle 100 being ahead of the follower vehicle 140. As such, the path 155 involves the follower vehicle 140 reversing into the parking space 150. In the exemplary scenario shown in FIG. 3, the front of the follower vehicle 140, which is normally the side of the follower vehicle 140 that is closest to the leader vehicle 100, is positioned ahead of the leader vehicle 100. Accordingly, the processes discussed with reference to FIG. 2 entail forward movement of the follower vehicle 140 along the path 155 to the parking space 150 shown in FIG. 3. The processes (e.g., path planning at block 220 or any of the other processes) are not limited to a particular direction of travel of the follower vehicle 140. Instead, the start position 160 and the location of the parking space 150 relative to that start position 160 determine the direction of travel of the follower vehicle 140 into the parking space 150.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method of parking a semi-autonomous follower vehicle, the method comprising:
performing, by a processor of the follower vehicle, path planning to determine a path from a current location of the follower vehicle to a parking space;
controlling, via vehicle-to-vehicle (V2V) communication, longitudinal movement of the follower vehicle using an accelerator control mechanism and a brake control mechanism operated by a driver of a leader vehicle that is not physically coupled to the follower vehicle, wherein the accelerator control mechanism includes a pedal, knob, or lever and the brake control mechanism includes a pedal, knob, or lever; and
controlling, via the processor of the follower vehicle, lateral movement of the follower vehicle in order to follow the path to the parking space.

2. The method according to claim 1, further comprising initiating the method from a start position at the current location, wherein the initiating includes putting the leader vehicle in park and the start position provides an unobstructed view of the path to the driver of the leader vehicle.

3. The method according to claim 2, wherein the initiating the method from the start position includes the leader vehicle being ahead of the follower vehicle at the current location such that the path is a reverse path from the current location to the parking space.

4. The method according to claim 2, wherein the initiating the method from the start position includes the leader vehicle being behind the follower vehicle at the current location such that the path is a forward path from the current location to the parking space.

5. The method according to claim 1, wherein the controlling the longitudinal movement of the follower vehicle via V2V communication refers to the follower vehicle obtaining a position of the accelerator control mechanism and the brake control mechanism of the leader vehicle via V2V communication.

6. The method according to claim 5, wherein the controlling the longitudinal movement of the follower vehicle includes mapping the position of the accelerator control mechanism and the brake control mechanism of the leader vehicle to a speed of the follower vehicle.

7. The method according to claim 1, wherein the controlling the lateral movement of the follower vehicle includes determining, by the processor of the follower vehicle, a steering angle continuously during movement of the follower vehicle from the current location to the parking space.

8. The method according to claim 7, wherein the controlling the lateral movement of the follower vehicle includes adding a bias to the steering angle determined by the processor of the follower vehicle based on V2V communication.

9. The method according to claim 8, wherein the adding the bias includes communicating a movement of a steering wheel of the leader vehicle by the driver of the leader vehicle.

10. The method according to claim 8, wherein the adding the bias includes the driver of the leader vehicle viewing sensor images obtained by the follower vehicle and provided via the V2V communication.

11. A system to perform semi-autonomous parking, the system comprising:
a processor of a follower vehicle configured to perform path planning to determine a path from a current location of the follower vehicle to a parking space and to control lateral movement of the follower vehicle in order to follow the path to the parking space; and
a leader vehicle that is not physically coupled to the follower vehicle and is configured to control, via vehicle-to-vehicle (V2V) communication, longitudinal movement of the follower vehicle using an accelerator control mechanism and a brake control mechanism operated by a driver of the leader vehicle, wherein the accelerator control mechanism includes a pedal, knob, or lever and the brake control mechanism includes a pedal, knob, or lever.

12. The system according to claim 11, wherein the leader vehicle is configured to initiate the semi-autonomous parking of the follower vehicle based on the leader vehicle being put in park.

13. The system according to claim 12, wherein the leader vehicle is ahead of the follower vehicle at the current location such that the path is a reverse path from the current location to the parking space.

14. The system according to claim 12, wherein the leader vehicle is behind the follower vehicle at the current location such that the path is a forward path from the current location to the parking space.

15. The system according to claim 11, wherein the follower vehicle is configured to obtain a position of the accelerator control mechanism and the brake control mechanism of the leader vehicle via V2V communication.

16. The system according to claim 15, wherein the follower vehicle is configured to map the position of the accelerator control mechanism and the brake control mechanism of the leader vehicle to a speed of the follower vehicle.

17. The system according to claim 11, wherein the follower vehicle is configured to determine a steering angle continuously during movement of the follower vehicle from the current location to the parking space.

18. The system according to claim 17, wherein the leader vehicle adds a bias to the steering angle determined by the follower vehicle based on the V2V communication.

19. The system according to claim 18, wherein the bias is added as a movement of a steering wheel of the leader vehicle by the driver of the leader vehicle that is communicated via the V2V communication.

20. The system according to claim 18, wherein the leader vehicle includes a display of sensor images obtained by the follower vehicle and provided via V2V communication.
